(19) United States
(12) Patent Application Publication
(10) Pub. No.: US 2007/0015538 A1
(43) Pub. Date: Jan. 18, 2007

(54) Network and method for the localization and customization of new mobile devices employing SIM/smart card

(76) Inventor: Eugene Wang, Laguna Niguel, CA (US)

Correspondence Address: McAndrews, Held & Malloy, Ltd., 34th Floor, 500 W. Madison St., Chicago, IL, 60661, US

(21) Appl. No.: 11/183,199

(22) Filed: Jul. 15, 2005

(51) Int. Cl. H04B 1/38

(52) U.S. Cl. 455/558

(57) ABSTRACT

A network with mobile devices supports localization and customization. A mobile device performs localization and customization using update packages retrieved from a SIM/Smart card in the mobile device or downloaded from a content server or a DM server. This facilitates localization of mobile devices using SIM/Smart cards that are manufactured for a location/locale/country with a different language/culture from the place where it is used the first time.

### RELATED APPLICATIONS

The present application makes reference to, claims priority to, and claims benefit of U.S. Provisional Patent Application Ser. No. 60/511,240, entitled “NETWORK AND METHOD FOR THE LOCALIZATION AND CUSTOMIZATION OF NEW MOBILE DEVICES EMPLOYING SIM/SMART CARD” (Attorney Docket No. 101USMD69), filed Oct. 14, 2003, the complete subject matter of which is hereby incorporated herein by reference, in its entirety.

The present application makes reference to PCT Application having publication number WO/02/41147 A1 and PCT Application No. PCT/US01/44034, entitled “System and Method for Updating and Distributing Information”, filed Nov. 19, 2001, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain firmware and application software that are either provided by the manufacturers of the electronic devices, by telecommunication carriers, or by third parties. These firmware and application software often contain software bugs. New versions of the firmware and software are periodically released to fix the bugs or to introduce new features, or both. An update agent in an electronic device can be employed to update the firmware/software in the electronic device.

Quite often, a carrier that services two different countries, A and B, each with its own local languages orders thousands of mobile devices for each country A and B. When sales in one of the countries, say A, is slack, excess mobile handsets from A are shipped to B for sales there. Unfortunately, due to the localization needs, all such phones need to be re-flashed with firmware and/or software, often at considerable expense to the carrier or manufacturer, or both.

Quite often, when mobile handsets of a particular make and model does not sell well in one country, it cannot be easily sold in a neighboring country even where there is a demand for it. That is because the mobile handsets are customized during manufacture for a given country, and such customization prohibits it's sale in another country. This is often due to the inappropriateness of the customization or the inability of the users at a different country to comprehend the user interface (language barriers). Thus, these mobile handsets may have to be reflashed at considerable expense at a service center before they can be sold in another country.

The problem of reflashing mobile devices, such as mobile handsets, often at considerable expense, in order to make them compatible with localization needs for the location where the mobile device is used (especially when the device was manufactured or assembled to be used elsewhere), is one that is quite widespread. For example, sales desks or sales kiosks that sell these mobile devices may be provided with expensive equipment that make it possible to reprogram or re-flash the mobile devices in order to make the user screens, keys, messages, etc. compatible with local languages.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or device supporting firmware update for customization and localization using an update agent in a mobile device, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a perspective diagram of a mobile handset that is used in a network, such as a carrier network, that can download update packages employing over-the-air (OTA) or other techniques and update its firmware and software, the update packages being generated by an update packager/generator and transferred employing an update package catalog format to a content server/update store that is communicatively coupled to the mobile handset, either directly or via a DM server/delivery server;

FIG. 2 is a flow chart of the operation of the mobile device in the network as it conducts localization and customization of the mobile device during its first-time use by a user;

FIG. 3 is another flow chart of the processing of the mobile device wherein localization and customization related update packages for the mobile device are retrieved either from a SIM/Smart card in the mobile device or downloaded from a content server or a DM server; and

FIG. 4 is a flow chart of an exemplary DM Server that supports localization and customization of mobile devices that are not manufactured or assembled for the locale or country in the locale or country where it is used.

### DETAILED DESCRIPTION OF THE INVENTION

Aspects of the present invention relate generally to the process of scheduling management tasks, such as updating software/firmware in electronic devices, and more specifically, to the use of a device management client with scheduling capabilities in an electronic device. The following discussion makes reference to the term “electronic device” that is used herein to refer to mobile electronic devices such as, for example, a mobile handset, a cellular phone, a personal digital assistant (PDA), a pager, and a personal computer, to name just a few. Although the listed example electronic devices are mobile devices, application of the present invention is not limited in this manner, as representative embodiments of the present invention may be employed in a wide variety of electronic devices, both fixed and mobile.

Electronic devices may be adapted to access servers to retrieve update information for updating memory in the electronic devices. An electronic device may be, for example, a mobile electronic device having firmware/software such as mobile cellular phone handsets, personal digital assistants (PDAs), pagers, MP-3 players, digital cameras, etc. Update information may comprise information that modifies or changes firmware/software and/or software components installed in the electronic device. In a representative embodiment of the present invention, update information may comprise a set of executable instructions for converting a first version of code to an updated/second version of code. The update information may add new services to the electronic device, as desired by a service provider, device manufacturer, or an end-user, and/or may fix bugs (e.g., software errors) in the operating code of the electronic device. In a representative embodiment of the present invention, update information may comprise an update package.

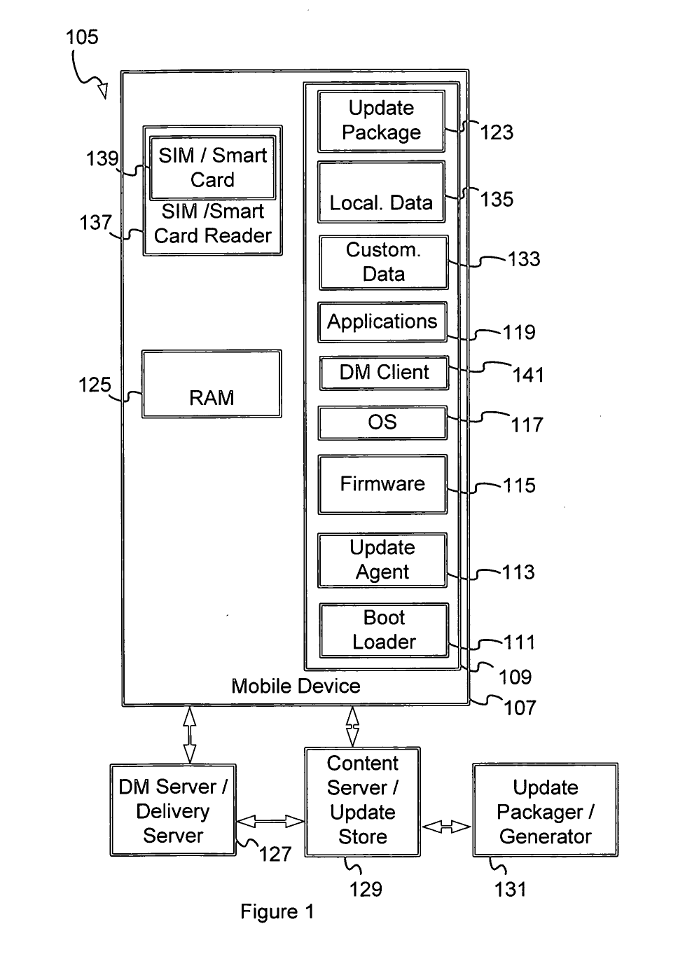

FIG. 1 is a perspective diagram of a network 105 for the localization and customization of new mobile devices that supports the localization and customization of a new mobile device 107 employing update packages that are either provided by a SIM/Smart card 139 inserted into the mobile device 107 or downloaded over-the-air from a content server 129 to which the mobile device 107 is communicatively coupled. In general, the mobile device 107 comprises a SIM/Smart card reader 137 with a SIM/Smart card issued by a wireless or telecom carrier, an update agent 113 that facilitates update of a firmware 115, an operating system (OS) 117, applications 119, a customization data 133 or a localization data 135.

The carrier issuing the SIM/Smart card 139 to a user for use in the mobile handset 107 also incorporates one or more update packages in the SIM/Smart card 139, such update packages to be selectively used for localization of the mobile device 107 or for customization of the mobile device 107 (such customization may be based on currently subscribed services).

If the mobile device 107 has been manufactured or assembled to be used at a different locale than the one where it is being used, then, before (or during) its first time use, the mobile device 107 attempts to localize it by updating data, code (firmware, software, applications, etc.), configuration and/or parameters, as necessary. The updating of such localization related code and data is facilitated by the update agent 113, which employs one or more update packages provided by a carrier (or other entity) in the SIM/Smart card 139.

When the SIM/Smart card 139 is inserted into the mobile device 107 for the very first time, the mobile device 107 determines the localization needs of the mobile device 107, determines the existence of localization and/or customization related update packages in the SIM/smart card 139, and employs the update agent 113 in the phone and one or more of the update packages available in the SIM/smart card to conduct localization and/or customization of the mobile device 107.

In one embodiment, the localization and/or customization related update packages in the SIM/smart card 139 are copied into the mobile device 107, such as into a non-volatile memory 109 in the of the mobile device 107, before they are employed by the update agent 113 to conduct localization and/or customization of the mobile device 107.

In one embodiment, the update agent 113 employs one or more update packages stored in the SIM/Smart card 139, directly, without copying them into a RAM 125 or the non-volatile memory 109.

In one embodiment, mobile handset 107 used in a network 105 (such as a carrier network), is capable of downloading update packages employing over-the-air (OTA) or other techniques and update its firmware 115 and software 117, 119, in order to localize the device when the mobile device 107 is determined (by the mobile device 107, by the DM server 127 in the carrier network or the user) not to have the appropriate localization. The SIM/Smart card would provide references, such as URLs, identifications, etc., that would facilitate the download of localization related update packages that may comprise of code (executable code, binary code, difference information etc.), data, configuration, etc.

Typically, update packages that are generated by an update packager/generator 131 are transferred, employing an update package catalog format, to a content server/update store 129 that is communicatively coupled to the mobile device 107, either directly or via a DM server/delivery server 127 that can deliver the update packages. The update packages delivered to the mobile device may be used for localization/customization of the mobile device 107, such as during the first-time use of a new mobile device 107 in the network 105.

The update packager/generator 131 creates one or more update packages that are useful for localization of a mobile device 107 that was created anticipating its use elsewhere, with different localization needs, such as at a different locale (that requires a different language support, different regulatory policies, etc.).

In one embodiment, the during its first usage, the mobile device 107 determines the locale needs and identifies localization update packages necessary, employs provisioning information (such as DM server/delivery server 127 URL, security settings etc.) provided in the SIM/smart card, and downloads one or more update packages (or files) needed to localize the mobile handset 107, such localization requiring providing appropriate language support, appropriate configuration parameters, appropriate set of user interaction screens, UI resources (such as java resource bundles) etc.

The content server/update store 129 is capable of parsing mobile device 107 requests for localization, submitted via the DM server/delivery server 127, selectively retrieving all or a subset of the necessary update packages, and communicating them to the mobile device 107—either via the DM server/delivery server 127 or directly.

The mobile device 107 is capable of selectively verifying the authenticity of the update packages received, either from a SIM/smart card 139, or from the Dm server/delivery server 127 (or the content server 129).

In one embodiment, the DM Server 127 is used in conjunction with a content server 129 to provide various localization and customization related update packages to the mobile device 107. In a different embodiment, the Delivery Server 127 is used in conjunction with a update store 129 to provide various localization and customization related update packages to the mobile device 107.

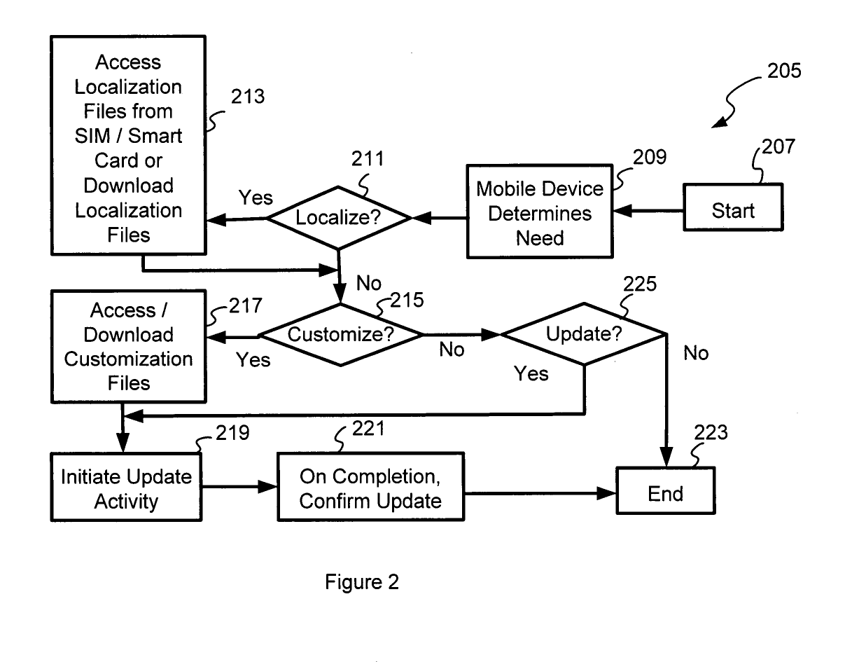

FIG. 2 is a flow chart 205 of the operation of the mobile device 107 in the network 105 as it conducts localization and customization of the mobile device 107 during its first-time use by a user. At a start block 207, the processing starts when the user inserts a SIM/smart card 139 into the mobile device 107. At the next block 209, the mobile device 107 determines the need to update the mobile device environment by conducting localization or customization. Localization would be deemed as necessary, for example, when the mobile device 107, as manufactured or originally assembled, does not support the local language, regulatory policies, currency, user interaction screens and content, etc. Customization would be deemed necessary, for example, when code, data, configuration, etc. need to be modified in the mobile device 107 in order to make all services available and useable to which the user has purchased subscriptions.

Then, at a next decision block 211, if it is determined that localization of the mobile device is necessary, then, at a next block 213, one or more update packages and associated files/data are accessed from the SIM/Smart card 139 for update of the mobile device 107. If the SIM/Smart card 139 does not provide actual update packages but only references (such as URL) to them, for example, as URL references in a device management tree segment maintained by the SIM/Smart card 139, then the mobile device 107 accesses those references from the SIM/Smart card 139 and subsequently retrieves the associated update packages and/or configuration information, files, etc. from the server or service located at those references. For example, the SIM/Smart card may provide a reference that is a URL of the content server or Update store 129 and the mobile device downloads update packages or other content from the content server or Update store 129. In one embodiment, localization comprises several categories of code, and data, such as a user interfaces, language, currency, date, date formats, etc. In general, localization may also result in modifications, enhancements to localization data 135, or its replacement

Later, at a next decision block 215, the need to customize the mobile device 107, such as with user preferences, code, data and configuration for user's current subscriptions to services, etc., is determined. If it is determined that the customization is necessary, then, at a next block 217, update packages, files and/or configuration data are accessed from the SIM/Smart card 139. These are then employed by one or more components in the mobile device 107, such as the update agent 113, to update the mobile device with the necessary firmware components, software components, configuration and data for the user. The determination of what components are needed for such customization is made based on user's current subscriptions to services, existing promotional packages, localization needs, etc. Customization may also result in modifications, enhancements to custom data 133, or its replacement. The SIM/Smart card may provide references, such as URL/URI, to external sources of customization data, such as to the DM Server/Delivery Server 127 or to a content server/update store 129. The mobile device downloads customization files from such external sources.

Then, at a next block 219, the update activity is initiated. The update of the mobile device 107 is conducted by the update agent 113. In one embodiment, the update agent 113 executes update activity following bootstrap by a boot loader 111, before any of the operating system 117 services are available. In this embodiment, a reboot of the mobile device 107 may be necessary following the update. In a different embodiment, the update agent 113 updates localization data 135 and/or customization data 133. And no reboot is necessary following the update. In another embodiment, localization and customization comprise of modifying, adding or removing one or more applications 119 and one or more components in the operating system 117. A reboot of the mobile device is selectively executed.

Then, on the completion of the update activities, at a next block 221, the message confirming the update is selectively displayed on the mobile device 107 for the user's benefit. In addition, a message indicating confirmation of the update is sent to an external source, such as a DM server 127.

Finally, the process terminates at an end block 223. At this point, the mobile device becomes operational with all the localization and customization needs of the user adequately addressed.

If, at the decision block 211, it is determined that the mobile device 107 does not require any localization, then, at a next step 215, an attempt is made to determine if it requires any customization. Again, if, at the decision block 215, it is determined that the mobile device 107 does not require any customization, then, at a next decision block 225, an attempt is made to determine if an update of the mobile device is necessary. If, it is determined that an update is necessary (for example, due to localization related update packages that are downloaded), then at the next block 219, the update activity is initiated. Otherwise, the process terminates at the end block 223.

In one embodiment, at the block 219, the update activity for localization and/or customization is also accompanied by an update of firmware, operating system or applications that might be necessary, the corresponding update package(s) being downloaded from a content ser server or a DM server.

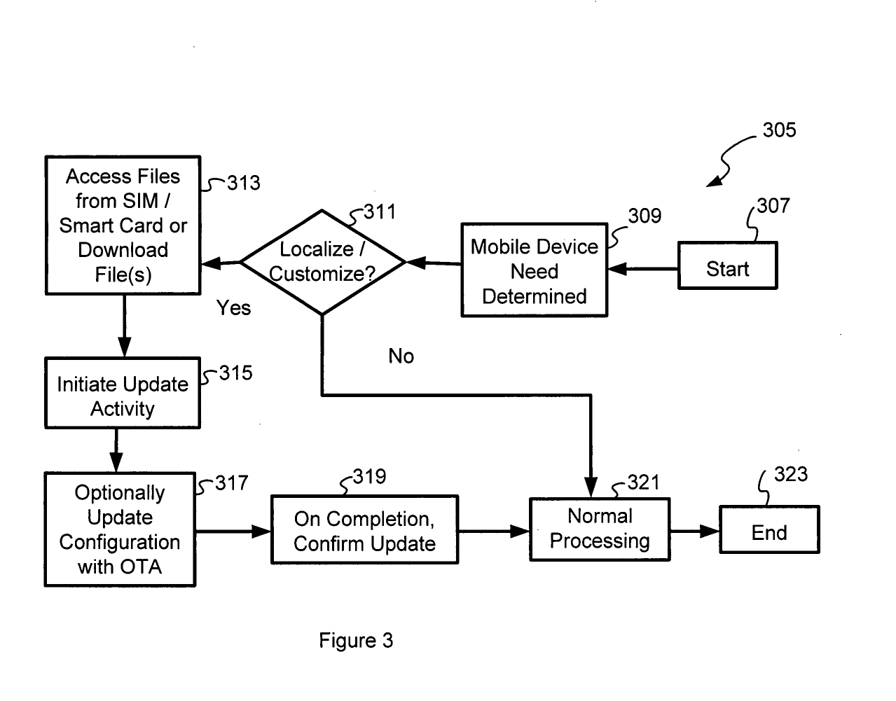

FIG. 3 is another flow chart 305 of the processing of the mobile device 107 wherein localization and customization related update packages for the mobile device are retrieved either from a SIM/Smart card in the mobile device or downloaded from a content server or a DM server. The localization and customization related information (code, data, parameters, configuration, etc.) may be combined in the same update package or provided as a set of update packages and/or files.

At a start block 307, the processing starts when the user inserts a SIM/smart card 139 into the mobile device 107. At the next block 309, the mobile device 107 determines the need to update the mobile device environment by conducting localization or customization. Localization would be deemed as necessary, for example, when the mobile device 107, as manufactured or originally assembled, does not adequately support the local language, regulatory policies, currency, user interaction screens and other content, etc. Customization would be deemed necessary, for example, when code, data, configuration, etc. need to be modified in the mobile device 107 in order to make all services available and useable to which the user has purchased subscriptions. The need to conduct localization would be evident if the mobile device were manufactured for use at a location (country/region) where the local language would be different from the one where the mobile device is brought to operational mode for the first time (for example, by first-time use). A locale parameter in the mobile device, for example, may be used as an indication of where the mobile device is expected to be used. If the mobile device 107 determines that the current locale of operation (say, during first-time use) is different than the locale determined from the mobile device, such determination optionally employing information stored in the SIM/Smart card, then the mobile device determines that localization activities need to be performed, employing localization related update packages, etc.

Then, at a next decision block 311, if it is determined that localization or customization of the mobile device is necessary, then, at a next block 313, one or more update packages and associated files/data are accessed from the SIM/Smart card 139 for update of the mobile device 107. If the SIM/Smart card 139 does not provide such update packages, then a DM Server is accessed to determine their availability and subsequently download them for update, if necessary. In one embodiment, the SIM/Smart card 139 does not provide update packages—instead, it provides references for them along with optional security parameters and/or search criteria. The mobile device 107 employs the references to subsequently download one or more update packages—the references can be URLs, for example, or references to actual update packages that another server in the network might know or dispense.

Then, at a next block 315, the update activity is initiated, to update the mobile device using the downloaded update packages. Then, at a next block 319, on the completion of the update activity, a confirmation message is sent (or error codes in case of failure) to a DM server or to another server in the network. If a reboot of the mobile device is needed following the update, then such a reboot is conducted before sending the confirmation message.

Then, at a next block 321, the normal processing of the mobile device is resumed. Finally, the processing terminates at an end block 323.

If, at the decision block 311, it is determined that the localization/customization is not necessary, then, at the next block 321, the normal processing of the mobile device is resumed, before processing terminates at the end block 323.

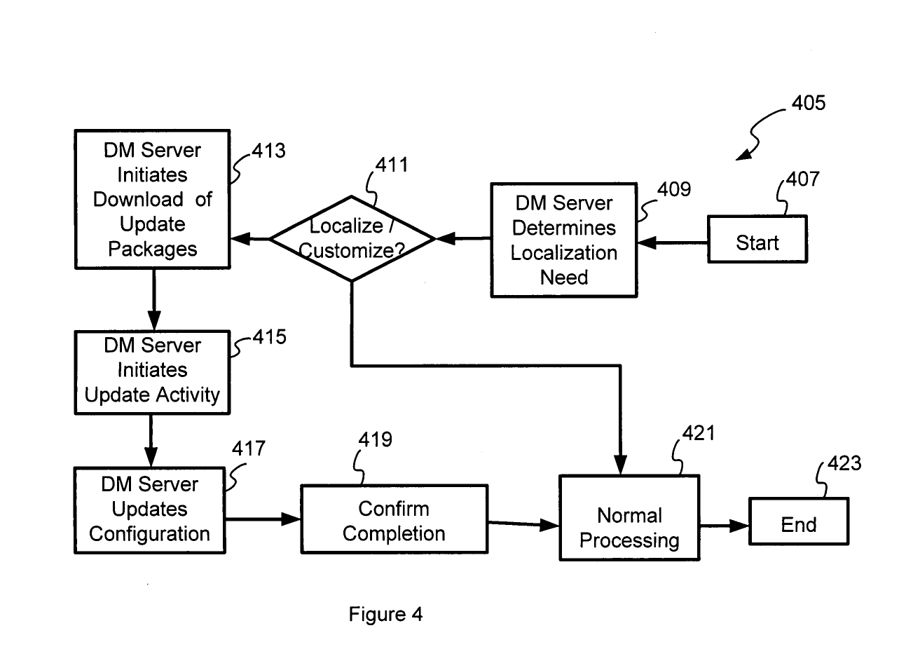

FIG. 4 is a flow chart 405 of an exemplary DM Server that supports localization and customization of mobile devices that are not manufactured or assembled for the locale or country in the locale or country where it is used. At a start block 407, the DM Server determines that a mobile device 107 requires services. At a next block 409, the DM Server determines that localization services are needed by the mobile device 107. This could be determined based on queries by the DM Server, based on a DM Tree accessed by the DM Server that is maintained by the mobile device, based on information communicated by the mobile device, etc. Similarly, customization needs of the mobile device can be determined by querying the mobile device or retrieving information from it. For example, retrieving information regarding services currently subscribed to by the mobile device user would be useful in determining customization needs. Additionally, information on subscriptions provided by the SIM/Smart card of the mobile device would also be helpful. Localization information could also be used to determine customization needs.

Then, at a next decision block 411, if it is determined that the mobile device 107 requires localization or customization services, then, at a next block 413, the DM Server initiates the download of appropriate update packages to the mobile device, such update packages being disseminated either by the DM Server or by a content server/update store.

Then, at a next block 415, the DM Server initiates update activity in the mobile handset. Such update activities requiring the use of one or more update agents (one or more that may be available). Subsequent to the download of update packages and the update of the mobile device 107, at a next block 417, the DM Server updates the configuration of the mobile device, if necessary. For example, default language settings, default currency settings, default date format, etc. may all be reconfigured in the mobile handset. Security settings, provisioning of server side information, etc. may also be set. Then, at a next block 419, after the completion of the update is confirmed, s confirmation message is displayed to the user, if needed, and a confirmation message is also sent to the DM server.

Then, at a next block 421, the normal processing of the mobile device commences before finally terminating at an end block 423.

If, at the decision block 411, it is determined that there is no need for localization/customization, then, at a next block 421, the normal processing of the mobile device commences before finally terminating at an end block 423

In one related embodiment, the update of configuration conducted in block 417 is executed after the confirmation of completion of the localization and customization process at the block 419, i.e. the positions of blocks 417 and 419 are swapped.

Thus, the network 105 with mobile devices supports localization and customization. The mobile device 107 performs localization and customization using update packages retrieved from a SIM/Smart card in the mobile device or downloaded from a content server or a DM server. This facilitates localization of mobile devices using SIM/Smart cards that are manufactured for a location/locale/country with a different language/culture from the place where it is used the first time.

In general, the device 107 manufactured to be operated in a network 105 in a first locale, is updated to operate in a second locale where it is not expected be used (by the manufacturer or the operator). The device 107 is thus capable of being modified to be operated at the second locale. The device 107 comprises a programmed card 137 that is one of a SIM card or a Smartcard. The device 107 retrieves a localization code from the programmed card when the device 107 is activated for the first time at the second locale. The device 107 updates itself using the localization code in order to be operational at the second locale.

In a related embodiment, the first locale and the second locale are different countries, or are associated with different regions within a country. They could also be associated with languages.

In another related embodiment, the device 107 comprises the firmware 115, the software 117, 119, a configuration, and a plurality of settings and wherein the localization code is an update package used to update at least one of the firmware, the software, the configuration, at least one of the plurality of setting in the device, appropriate language support, set of user interaction screens, and user interface resources. It may also comprise of the local data 135 and custom data 133. The localization code is thus used to modify, as necessary, configuration, software and firmware components such that the user can use the device 107 at a new or different locale than the one the device 107 was manufactured for.

In another related embodiment, the device 107 retrieves a reference to the localization code from the programmed card when the device is activated for the first time at the second locale and subsequently downloads the localization code using the reference. In addition, the device 107 retrieves a reference to a management server from the programmed card and initiates a management session with the management server when the device 107 is activated for the first time at the second locale. In a different but related embodiment, the device 107 initiates a management session with the management server 127 to retrieve a localization code in order to update the device.

The method of localization of a mobile device 107 that is communicatively coupled to a management server 127 may comprise detecting that the device is being used at a new locale; retrieving a localization update package from a Smartcard associated with the device; incorporating, by a management client in the mobile device, the localization update package; and reporting, by the management client, a status to the management server.

In an embodiment of the present invention, the incorporating process of the method of localization may comprise determining if a firmware of the device needs to be updated, based on the localization update package; updating the firmware; and rebooting the device, if necessary. In a related embodiment, the incorporating process may further comprise modifying a configuration of the device, as necessary, based on the localization update package. In another related embodiment, it may further comprise customizing the device by downloading customization files and installing them.

In one embodiment of the method of localization, detecting that the device is being used at a new locale comprises monitoring, by the device, the insertion of a Smartcard; accessing a new locale information from the Smartcard; and verifying that the device does not yet support usage at the new locale.

Aspects of the present invention may be seen in a device management server 127 that supports localization and customization of mobile devices 107 that are not manufactured or assembled for the locale or country where the mobile device is used. The device management server 127 comprises the device management server determining that localization is needed by the mobile device. The device management server provides a localization update package to the mobile device and instructs the mobile device to install the localization update package.

In a related embodiment, the device management server retrieves a device information from a device management client in the mobile device 107, in order to determine that localization is needed for the mobile device 107. In another related embodiment, the device information retrieved by the device management server 127 comprises at least one of a country code, a network code, a manufacturer code, a language code, a model number and a locale identifier. In a different yet related embodiment, the device information retrieved by the device management server 127 comprises information retrieved from a SIM/Smartcard 139 associated with the mobile device 107.

In another related embodiment, the device management server retrieves information from the SIM/Smartcard 139. The information retrieved from the SIM/Smartcard 139 comprises at least one of a country code, a network code, subscriber identification, a language code, a service plan identification and a locale identifier.

In yet another related embodiment, the device management server 127 determines that the mobile device 107 requires access to a subscribed service and facilitates a service configuration associated with the subscribed service. In a related embodiment, the device management server 127 retrieves service information from a device management client in the mobile device 107 regarding the subscribed service, determines customization needs, and manages the delivery and installation of an associated customization update package. In addition, the customization update package may comprise at least one of a configuration data, a logo, a screen saver, a digital rights management object, and an account information.

In another embodiment, the device management server 127 receives a localization request from the mobile device 107 when the mobile device 107 determines that a current locale of operation indicated by the SIM/Smartcard 139 in the mobile device is different from a default locale associated with the mobile device 107, and, in response, communicates a localization update package to the mobile device to localize the mobile device.

In a different embodiment of the present invention, the device management server 127 receives a management session request from the mobile device 107, determines the need to localize the device, and, in response, communicates a localization update package to the mobile device 107 to localize the mobile device 107.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A device manufactured to be operated in a network in a first locale, the device capable of being modified to be operated at a second locale, the device comprising:
a programmed card that is one of a SIM card or a Smartcard;
the device retrieving localization code from the programmed card when the device is activated for the first time at the second locale;
the device updating itself using the localization code in order to be operational at the second locale.

2. The device of claim 1 wherein the first locale and the second locale are different countries.

3. The device of claim 2 wherein the device further comprises a firmware, a software, a configuration, and a plurality of settings and wherein the localization code is an update package used to update at least one of the firmware, the software, the configuration, at least one of the plurality of setting in the device, appropriate language support, set of user interaction screens, and user interface resources.

4. The device of claim 2 wherein device retrieves a reference to the localization code from the programmed card when the device is activated for the first time at the second locale and subsequently downloads the localization code using the reference.

5. The device of claim 2 wherein the device retrieves a reference to a management server from the programmed card and initiates a management session with the management server when the device is activated for the first time at the second locale.

6. The device of claim 5 wherein the device initiates a management session with the management server to retrieve a localization code in order to update the device.

7. A method of localization of a mobile device that is communicatively coupled to a management server, the method comprising:
detecting that the device is being used at a new locale;
retrieving a localization update package from a Smartcard associated with the device;
incorporating, by a management client in the mobile device, the localization update package; and
reporting, by the management client, a status to the management server.

8. The method of localization according to claim 4 wherein the incorporating comprises:
determining if a firmware of the device needs to be updated, based on the localization update package, and updating the firmware; and
rebooting the device, if necessary.

9. The method of localization according to claim 8 wherein the incorporating further comprises:
modifying a configuration of the device, as necessary, based on the localization update package;

10. The method of localization according to claim 8 wherein the incorporating further comprises customizing the device by downloading customization files and installing them.

11. The method of localization according to claim 8 detecting that the device is being used at a new locale comprises:
monitoring, by the device, the insertion of a Smartcard;
accessing a new locale information from the Smartcard; and
verifying that the device does not yet support usage at the new locale.

12. A device management server that supports localization and customization of mobile devices that are not manufactured or assembled for the locale or country where the mobile device is used, the device management server comprising:
the device management server determining that localization is needed by the mobile device.
the device management server providing a localization update package to the mobile device and instructing the mobile device to install the localization update package.

13. The device management server of claim 12 wherein the device management server retrieves a device information from a device management client in order to determine that localization is needed for the mobile device.

14. The device management server of claim 13 wherein the device information retrieved by the device management server comprises at least one of a country code, a network code, a manufacturer code, a language code, a model number and a locale identifier.

15. The device management server of claim 13 wherein the device information retrieved by the device management server comprises information retrieved from a Smartcard associated with the mobile device.

16. The device management server of claim 15 wherein the information retrieved from the Smartcard comprises at least one of a country code, a network code, subscriber identification, a language code, a service plan identification and a locale identifier.

17. The device management server of claim 12 wherein the device management server determines that the mobile device requires access to a subscribed service and facilitates a service configuration associated with the subscribed service.

18. The device management server of claim 17 wherein the device management server retrieves service information from a device management client in the mobile device regarding the subscribed service, determines customization needs, and manages the delivery and installation of an associated customization update package.

19. The device management server of claim 18 wherein the customization update package comprises at least one of a configuration data, a logo, a screen saver, a digital rights management object, and an account information.

20. The device management server of claim 12 wherein the device management server receives a localization request from the mobile device when the mobile device determines that a current locale of operation indicated by the Smartcard in the mobile device is different from a default locale associated with the mobile device, and, in response, communicates a localization update package to the mobile device to localize the mobile device.

21. The device management server of claim 12 wherein the device management server receives a management session request from the mobile device, determines the need to localize the device, and, in response, communicates a localization update package to the mobile device to localize the mobile device.
